(19) United States
(12) Patent Application Publication
(10) Pub. No.: US 2015/0130941 A1
(43) Pub. Date: May 14, 2015

(54) CAMERA MODULE, IN PARTICULAR FOR A VEHICLE

(71) Applicant: Robert Bosch GmbH, Stuttgart (DE)

(72) Inventors: Nikolai Bauer, Moeglingen (DE); Ulrich Seger, Leonberg-Warmbronn (DE)

(21) Appl. No.: 14/396,648

(22) PCT Filed: Apr. 10, 2013
(86) PCT No.: PCT/EP2013/057488

§ 371 Date: Oct. 23, 2014

(30) Foreign Application Priority Data
Apr. 25, 2012 (DE) 10 2012 206 831.7

(51) Int. Cl. H04N 5/225; G03B 13/32

(52) U.S. Cl. CPC H04N 5/2254; G03B 13/32; H04N 5/2253
USPC 348/148; 29/592.1

(57) ABSTRACT

A camera module for a vehicle includes: one objective including a lens mount and at least one lens accommodated in the lens mount; one objective receptacle into which the objective is inserted; one image sensor attached to the objective receptacle, the objective being inserted into a receptacle area of the objective receptacle and being longitudinally shiftable in the receptacle area along an optical axis for adjustment or setting of the objective in relation to the image sensor provided at one end of the receptacle area. The objective is fixed to the objective receptacle in a press-fit connection formed outside of the receptacle area.

### BACKGROUND OF THE INVENTION

1. Field of the Invention

The present invention relates to a camera module which is usable in a vehicle in particular.

2. Description of the Related Art

Such a camera module generally has an objective receptacle and an objective inserted into the objective receptacle, the objective in turn essentially having a lens mount and one or more lenses inserted into the lens mount. The lenses may be inserted into the lens mount in a form-locked or a frictionally engaged manner; they may also be inserted to form an integral connection or molded in when the lens mount is formed. An image sensor of the camera module is directly attached to the objective receptacle or to a circuit substrate, to which the objective receptacle is attached.

The objective is thus placed into a receptacle area of the objective receptacle, which is defined by a preferably cylindrical wall, and is adjusted in the longitudinal direction along the optical axis defined by the image sensor and the objective; during the adjustment, the image signals output by the image sensor are evaluated in order to achieve a suitable focusing of, for example, a test pattern situated in the desired object distance. Here, the outer surface of the lens mount correspondingly slides on an inner surface of the wall area, which thus form fitting surfaces.

The fixing of the objective in the objective receptacle may be carried out by an introduced adhesive or additional means such as inserted screws; however, such attachments are time-consuming or may result in misalignment; an adhesive must, for example, be cured over an extended period of time or must be cured, for example, by additional UV irradiation; screws, etc., may result in particle intrusion or mechanical stresses. Therefore, press-fit connections between the objective and the objective receptacle are known. For this purpose, the lens mount is pressed into the objective receptacle, so that a press-fit connection is formed between the outer surface of the lens mount and the inner surface of the objective receptacle.

When the objective is integrated into the objective receptacle, a position check is thus made; this position-checked joining is supported by suitable fitting surfaces on the outer surface of the objective mount and the inner surface of the wall area of the lens receptacle, making it possible to reduce the tolerance of the positioning of the optical axis or axis of rotation of the objective in relation to the optical axis of the image sensor.

In particular, when unpackaged or unprotected image sensors are used, it is possible that particles produced by friction during joining, i.e., abraded material between the outer wall of the lens mount and the inner wall or inner surface of the objective receptacle, may impair the performance of the image sensor. For this purpose, it is known to use seals beneath the fitting surfaces which, however, may emit particles and result in additional expense.

### BRIEF SUMMARY OF THE INVENTION

According to the present invention, the at least one press-fit connection is provided outside of the receptacle area in which the objective receptacle (lens barrel) accommodates the objective. A lens rear chamber between the image sensor and the at least one lens forms in particular a (lower) part of the receptacle area.

The receptacle area may in particular be defined by a, for example, cylindrical wall of the objective receptacle, the inner surface of which thus accommodates an outer surface of the lens mount or the lens mount body and thus is also used as a guide when inserting the objective. Since the press-fit connection is not formed between these two surfaces, it is possible to minimize or entirely avoid the entry of abraded particles of these surfaces into the lens rear chamber and thus onto the image sensor.

The press-fit connections may in particular lie radially outside of these two surfaces or guide surfaces, i.e., radially outside of the receptacle area. For this purpose, for example, the objective, in particular its lens mount, may include a laterally (radially) projecting area, which may in particular be formed in an upper area of the lens mount.

According to one advantageous embodiment, the press-fit connections may be formed as stud and receptacle engagements, in particular between a radially outward projecting collar of the lens mount and the upper surface or a laterally outward projecting part of the wall area of the objective receptacle. In principle, each of the two parts may include the studs or the receptacles; here, in particular, the receptacles may be formed as blind holes in the wall or the wall area of the objective receptacle and accommodate the downward projecting studs of the lens mount.

Since the receptacles are formed as downward (i.e., in the direction of insertion) closed blind holes, abraded particles consequently fall downward into the blind hole during insertion or adjustment and are safely separated from the image sensor or a lens rear chamber between the at least one lens and the image sensor.

Several advantages are achieved according to the present invention:

A press-fit is possible between the lens mount and the objective receptacle, which has advantages compared to, for example, adhesive bonds or fixations by additional means; the risk of a particle emission onto the image sensor or into a lens rear chamber between the lens and image sensor is, however, reduced or entirely prevented.

The formation of blind holes as receptacles of the press-fit connections in particular makes it possible for the abraded particles to fall into the blind hole.

A pressing or press-fit connection having a high frictional force is made possible, so that a secure joint is achieved over the service life of the camera module.

Furthermore, multiple press-fit connections are possible for stabilizing the joint; the multiple press-fit connections may in particular be distributed in the circumferential direction around the optical axis, for example, as three press-fit connections. The press-fit connection advantageously has no effect on the lens mount, making it possible to prevent the imaging elements from being subjected to pressure, in particular including the image sensor or the at least one lens. Here, a possible stress on this area is limited if a laterally outward projecting collar and a stud projecting downward from it is formed; this does not adversely affect the cylindrical part of the lens mount including the at least one accommodated lens. Also, a possible stress present in the upper area of the objective receptacle does not have an effect on the image sensor (lying underneath in the direction of insertion). Consequently, the image quality is not adversely affected by distortion or stresses.

It is possible to manufacture the camera module cost-effectively and rapidly; the components as such may be formed without additional expense or without significantly higher expense; the press-fit connections may be formed at the same time by appropriate forming of the lens mount and the objective receptacle, for example, during the injection molding of these components. The joining process including adjustment is possible by simple axial displacement along the optical axis, without additional method steps such as curing of an adhesive or introducing additional mechanical means.

### BRIEF DESCRIPTION OF THE DRAWINGS

FIG. 1 shows a section through a camera module according to one specific embodiment of the present invention.

FIG. 2 shows perspective representations of the objective receptacle and the lens mount body.

FIG. 3 shows a detail enlargement from FIG. 1 of the press-fit elements stud and stud receptacle.

### DETAILED DESCRIPTION OF THE INVENTION

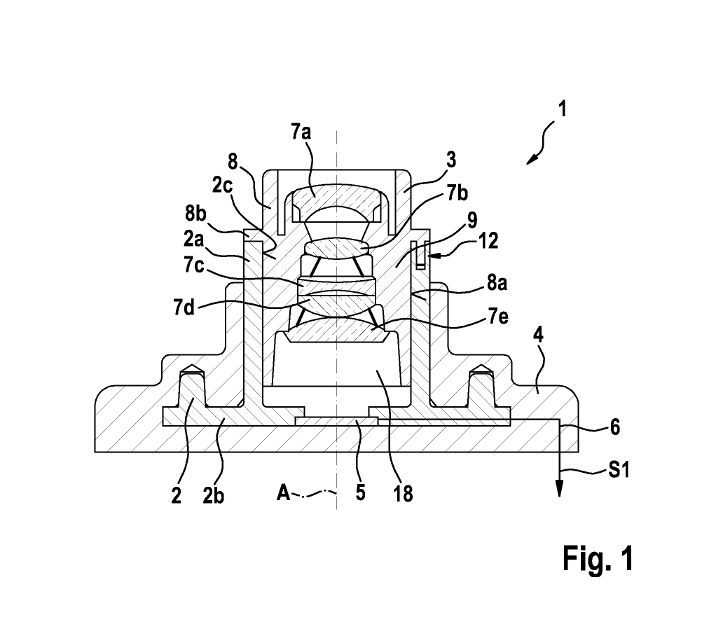

A camera module 1 shown in FIG. 1 includes an objective receptacle 2 having a tubular wall area 2a and a, for example, plate-shaped assembly area 2b, and furthermore an objective 3 and external packaging 4, which, for example, may be formed by molding and is used for assembly in a vehicle. An image sensor (imager chip) 5 is accommodated in assembly area 2b and is also preferably directly contacted; assembly area 2b is thus used advantageously as a circuit substrate for contacting image sensor 5 and thus for the voltage supply and recording of image signals S1, which may be read out as image signals S1 directly or, if necessary, after further processing by electronic elements or circuits via terminals 6, for example, encapsulated lines or L-frames in packaging 4.

Objective 3 includes multiple lenses 7a, 7b, 7c, 7d, 7e and a lens mount (lens mount body) 8, in which lenses 7a through 7e are fixedly accommodated, for example, in a form-locked and/or in a frictionally engaged manner; lenses 7a through 7e may also be directly encapsulated when lens mount 8 is formed. If necessary, spacers are provided between lenses 7a through 7e for positioning the lenses and also accommodated or encapsulated, for example, in lens mount 8.

Image sensor 5 and objective 3 define an optical axis A of camera module 1. Focusing and adjustment is carried out by insertion and longitudinal adjustment of objective 3 in objective receptacle 2, i.e., by a longitudinal shift along optical axis A; a test pattern (not shown here) is detected by image sensor 5 during this adjustment, and its output image signals S1 are evaluated to achieve a sharp image based on a high contrast, and thus achieve a precise adjustment, in particular for an infinite object distance.

According to the shown specific embodiment, a fixation of objective 3 or its lens mount 8 in objective receptacle 2 may be carried out by a press-fit and/or a friction-fit. Here, a press-fit area is provided between lens mount 8 and the tubular wall area in press-fit connections 12, which are formed outside of an outer surface 8a of lens mount 8 and an inner surface 2c of wall area 2a.

Cylindrical inner surface 2c of wall area 2a defines a receptacle area 9, into which the objective is inserted. A lens rear chamber 18 formed between lowest lens 7e and image sensor 5 is thus a part of receptacle area 9.

The longitudinal adjustment is carried out by guiding cylindrical outer surface 8a of lens mount 8 in cylindrical inner surface 2c of assembly area 2b. Outer surface 8a thus slides in inner surface 2c. According to FIG. 1, lens mount 8 advantageously includes a collar, for example, an annular collar (shoulder) 8b. Between collar 8b and upper surface 2d of wall 2a press-fit connections 12 are formed, each of which is formed by a stud 14 projecting out downward from collar 8b, and a stud receptacle 15 is formed in wall 2a. Press-fit connections 12 are thus separated from the guide formed by inner surface 2c and outer surface 8a. As an alternative to this design on upper surface 2d, they may also be formed on wall 2a, i.e., on outer surface 2e of wall 2a.

Stud receptacles 15 are advantageously formed as blind holes extending downward from upper surface 2d, studs 14 being pressed into the blind holes from above.

Collar 8b preferably does not contact the wall area.

The design including shoulder 8b and stud 14 is preferably elastic, so that stresses may be captured there and not transferred to the cylindrical area of lens mount 8, so that also the position of lenses 7a through 7e in lens mount 8 is not affected by this; the optical axis is thus not influenced by the mechanical stresses of press-fit connections 12.

Studs 14 and stud receptacles 15 may, for example, have different cross sections, for example, round and polygonal, such as, for example, octagonal, so that a deformation and thus a press-fit is formed during insertion.

As an alternative to the shown cylindrical design, other designs are also possible, for example, having a thickened end of studs 14, which is somewhat deformed when pressed into receptacle 15. The abrasive particles produced on studs 14 and/or stud receptacles 15 during the press-fit thus fall to the bottom of stud receptacles 15.

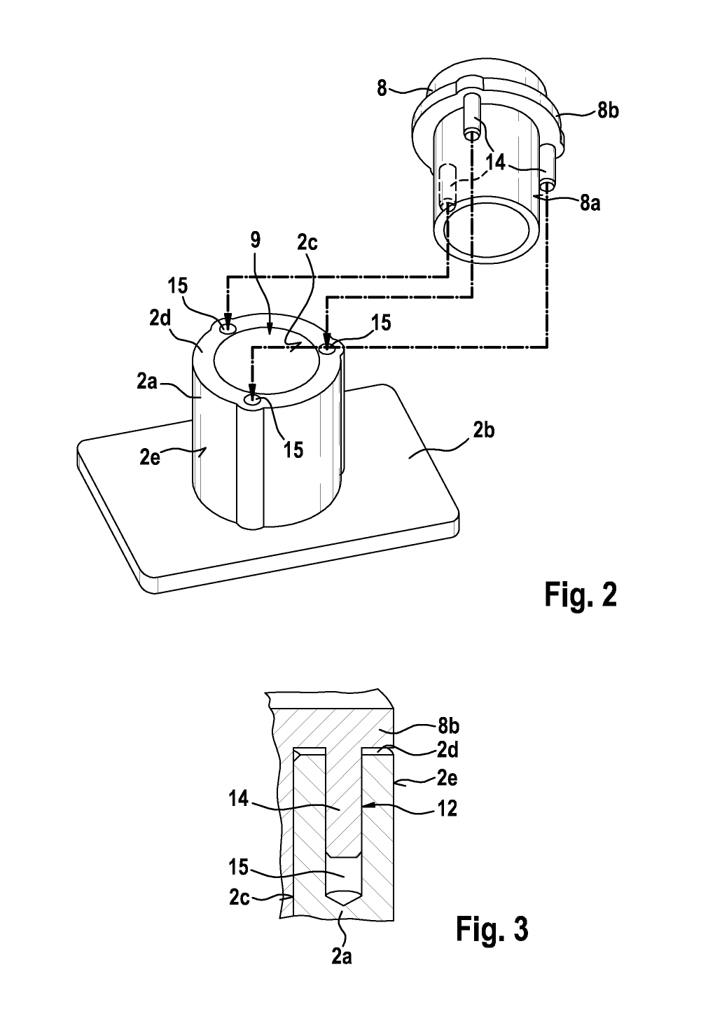

According to the shown specific embodiment, three press-fit connections 12 are provided distributed in the circumferential direction, i.e., three studs 14 are accordingly formed on collar 8b and three stud receptacles 15 are accordingly formed in wall area 2a. According to FIG. 2, wall area 2a may be designed to be somewhat thicker in the area of receptacles 15; its inner surface 2c is cylindrical in conformity with outer surface 8a.

In the case of this specific embodiment, lens mount 8 may thus be rotated in wall 2a in 120° steps about optical axis A, in order to achieve a preferred position of rotation. As an alternative to this, however, receptacles having a fixation of the position of rotation are also possible.

1-13. (canceled)

14. A camera module for a vehicle, comprising:
an objective including a lens mount and at least one lens accommodated in the lens mount;
an objective receptacle into which the objective is inserted; and
an image sensor attached to the objective receptacle;
wherein the objective is inserted into a receptacle area of the objective receptacle and is longitudinally shiftable in the receptacle area along an optical axis for adjustment of the objective in relation to the image sensor, the image sensor being provided at one end of the receptacle area, and the objective being fixed to the objective receptacle in at least one press-fit connection by frictional engagement, wherein the at least one press-fit connection is formed outside of the receptacle area.

15. The camera module as recited in claim 4, wherein the receptacle area includes a lens rear chamber formed between the at least one lens of the objective and the image sensor.

16. The camera module as recited in claim 15, wherein a wall area of the objective receptacle surrounds the receptacle area and the objective including one outer surface of the lens mount is guided on an inner surface of the wall area along the optical axis, the at least one press-fit connection being formed outside of the inner surface of the wall area and the outer surface of the lens mount.

17. The camera module as recited in claim 16, wherein the inner surface of the wall area and the outer surface of the lens mount are formed to be essentially cylindrical.

18. The camera module as recited in claim 16, wherein the at least one press-fit connection is formed between a radially outward projecting area of the lens mount and one of an upper surface or outer surface of the wall area of the objective receptacle.

19. The camera module as recited in claim 18, wherein the at least one press-fit connection is formed in the radial direction outside of the receptacle area.

20. The camera module as recited in claim 19, wherein the at least one press-fit connection is formed between a radially outward projecting area of the lens mount and the upper surface of the wall area.

21. The camera module as recited in claim 19, wherein the at least one press-fit connection is formed by a stud receptacle and an elongated stud pressed into the stud receptacle.

22. The camera module as recited in claim 21, wherein the stud has a different external form than the stud receptacle to achieve deformation when the stud is inserted into the stud receptacle.

23. The camera module as recited claim 21, wherein the stud receptacle is formed as at least one of a blind hole and a receptacle having an opening on one side which is closed by the inserted stud.

24. The camera module as recited in claim 21, wherein multiple press-fit connections are distributed in the circumferential direction around the optical axis.

25. The camera module as recited in claim 24, wherein the multiple press-fit connections are provided for defining an angular position of the objective in relation to the objective receptacle.

26. A method for manufacturing a camera module, comprising:
inserting an objective into a receptacle area of an objective receptacle, wherein an image sensor is attached to the objective receptacle;
adjusting the camera module by longitudinally shifting the objective in the receptacle area while evaluating image signals of the image sensor; and
fixing the objective in the objective receptacle in the desired position by a press-fit connection, wherein the press-fit connection is formed outside of the receptacle area.
